(19) United States
(12) Patent Application Publication
(10) Pub. No.: US 2014/0098521 A1
(43) Pub. Date: Apr. 10, 2014

(54) Backlight Module and LCD Device

(71) Applicant: Yajun Yu, Shenzhen City (CN)

(72) Inventor: Yajun Yu, Shenzhen City (CN)

(73) Assignee: SHENZHEN CHINA STAR OPTOELECTRONICS TECHNOLOGY CO. LTD., Shenzhen, Guangdong (CN)

(21) Appl. No.: 13/697,859

(22) PCT Filed: Oct. 24, 2012
(86) PCT No.: PCT/CN2012/083436

§ 371 Date: Nov. 14, 2012

(30) Foreign Application Priority Data
Oct. 10, 2012 (CN) 201210381342.3

(51) Int. Cl. G09F 13/04

(52) U.S. Cl. CPC G09F 13/04
USPC 362/97.2; 362/97.1

(57) ABSTRACT

The present invention discloses a backlight module, the backlight module comprising: a backplane comprising a hollow portion; a reflective sheet having a reflective surface and a non-reflective surface, and assembled to the backplane; and a light shading layer disposed between the backplane and the reflective sheet for shading the hollow portion. The present invention also discloses an LCD device having the backlight module. The backlight module and the LCD device can shade the light transmitting through the reflective sheet to avoid the light leakage and the 3D scan flashing of the backlight module and can achieve safety standards, simplify the assembly steps, and conducive to cost control.

The claims of this application have submitted to the State Intellectual Property Office of the People's Republic of China (SIPO) on Oct. 10, 2012, Application No. 201210381342.3. The priority right based on the China application has a title of “a backlight module and an LCD device”. The entire contents of the above-mentioned patent application will be incorporated in the present application through citing.

### BACKGROUND OF THE INVENTION

1. Field of the Invention

The present invention relates to the field of liquid crystal display, and more particularly to a backlight module and a liquid crystal display (LCD) device.

2. Description of Related Art

The conventional LCD module usually designs a backplane with a hollow portion in order to save the amount of backplane materials. Therefore, the LCD module production cost can be further reduced.

The backplane with a hollow portion exist the following problems:

1. When the LCD module is lighted on, the white reflective sheet behind the module will transmit light from the hollow portion of the backplane so as to produce light leakage phenomenon. The light leakage phenomenon makes the entire module look very bright from the back and very uncomfortable visually.

At the same time, when using 3D scanning function during playing 3D movies, the back of the LCD device continues to flash brightly and darkly. This will seriously interfere with the viewer in front of the LCD device. Customers and consumers are unable to accept.

2. After assembly of the LCD module, the power board or the system board and other circuit boards are fixed on the bracket of the backplane with a hollow portion. And they abut to the reflective sheet disposed on the backplane with a hollow portion. There is no barrier object between the circuit boards and the reflective sheet. Since the reflective sheet using in the LCD module belong to a foaming type. This type of the reflective sheet does not resist fire and is easy to effect by the high temperature of the circuit boards such that the entire module cannot achieve fire and safety standards.

In summary, there exist light leakage and fire safety issues caused by the backplane with a hollow portion of the LCD module, and the solution of the issues is particularly important and urgent.

### SUMMARY OF THE INVENTION

The present invention provides a backlight module and an LCD device. It can solve the light leakage and the 3D scan flashing problems.

The present invention also can solve the fire resistant problem and safety standards problem of the backlight module.

To solve the above technical problems, the present invention provides a backlight module comprising: a backplane comprising a hollow portion; a reflective sheet having a reflective surface and a non-reflective surface, and assembled to the backplane; and a light shading layer disposed between the backplane and the reflective sheet for shading the hollow portion.

Wherein, the light shading layer is a light shading film made from a fire-resistant material, and the light shading film is fixed to the backplane.

Wherein, the light shading film comprises a black fire-resistant polyester film or a black shading PET film.

Wherein, the light shading film has a similar shape corresponding to the hollow portion.

Wherein, the light shading layer is made from a fire-resistant material and adhered to the non-reflective surface of the reflective sheet.

Wherein, the light shading layer is a black fire-resistant polyester film.

Wherein, the light shading layer is a fire-resistant particle layer coated on the non-reflective surface of the reflective sheet corresponding to the hollow portion of the backplane.

Furthermore, the present invention also provides an LCD device having the above backlight module.

The backlight module and the LCD device provided by the present invention, because a light shading film is disposed between the backplane with the hollow portion and reflective sheet, the light shading layer is adhered on the non-reflective surface of the reflective sheet, or a fire-resistant particle layer is coated on the non-reflecting surface of the reflective sheet corresponding to the hollow portion of the backplane. It can shade the light transmitting through the reflective sheet to avoid the light leakage and the 3D scan flashing of the backlight module and can achieve safety standards, simplify the assembly steps, and conducive to cost control.

### BRIEF DESCRIPTION OF THE DRAWINGS

FIG. 1 is an exploded view of a backlight module according to a first embodiment of the present invention.

FIG. 2 is a schematic view of a reflective sheet of a backlight module according to a second embodiment of the present invention.

### DETAILED DESCRIPTION OF THE PREFERRED EMBODIMENT

The following content combines the drawings for describing preferred embodiments of the present invention.

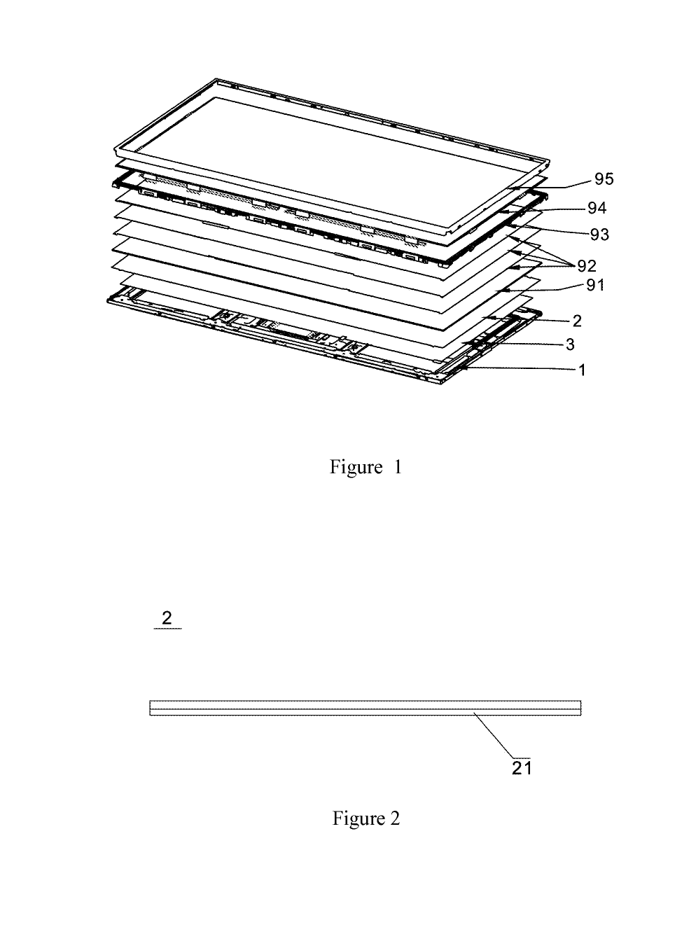

With reference to FIG. 1, this is an exploded view of a backlight module according to a first embodiment of the present invention.

The backlight module of the present invention comprises: a backplane 1, a reflective sheet 2 and other structural members. The reflective sheet 2 comprises a reflective surface and a non-reflective surface. Wherein, the non-reflective surface of the reflective sheet 2 is assembled to the backplane 1, and the reflective surface of the reflective sheet 2 is assembled to the other structural members.

The other structural members are assembled to the positions shown in FIG. 1. From the bottom to the top, it sequentially provides with a light guide plate 91, optical sheets 92, a plastic frame 93, a glass assembly 94 and a front frame 95.

Some portions of the backplane 1 are hollow to reduce the cost of the backlight module and meet the light and thin development requirement of the backlight module.

In this embodiment, a light shading film 3 is disposed between the backplane 1 with hollow portions and the reflective sheet 2 as shown in FIG. 1.

The light shading film 3 can shade the reflective sheet 2 revealed at the hollow portions of the backplane 1 to prevent the light transmitting through the hollow portions of the backplane 1 when the module is operating so as to solve the 3D scan flashing and the light leakage problem when the module is operating.

Specifically, it can directly attached a black shading PET (Polyethylene terephthalate) film as the light shading film 3 to the interior of the backplane 1 and dispose the reflective sheet 2 above the black shading PET film 3 such that the black shading PET film 3 can effectively shade the light transmitting through the reflective sheet 2.

Preferably, the light shading film 3 is made from a fire-resistant material. Thus, the light shading film 3 disposed between the backplane 1 and the reflective sheet 2 can solve the light leakage and the 3D scan flashing problems, and also solve the safety problem due to the use of the fire-resistant material.

In a second embodiment of a backlight module of the present invention, the backlight module comprises: a backplane 1, a reflective sheet 2, and other structural members. The reflective sheet 2 comprises a reflective surface and a non-reflective surface. Wherein, the reflective surface of the reflective sheet 2 is assembled to the other structural members.

The other structural members are assembled according to the position shown in FIG. 1. From the bottom to the top, it sequentially provides with a light guide plate 91, optical sheets 92, a plastic frame 93, a glass assembly 94 and a front frame 95.

The difference between this embodiment and the first embodiment is providing a reflective sheet 2 having a light shading layer 21 to replace the light shading film 3.

As shown in FIG. 2, it is a schematic view of a reflective sheet of a backlight module according to a second embodiment of the present invention. The light shading layer 21 is adhered to the non-reflective surface of the reflective sheet 2 such that the reflective sheet 2 forms a multilayer film structure. The light shading layer 21 functions as the light shading film 3 mentioned above, that is, shading the light transmitting through the reflective sheet 2 so as to prevent the light leakage and the 3D scanning flashing problems when the module is operating.

Similarly, the light shading layer 21 can be made from a fire-resistant material, and it is capable to solve the safety problem.

In this embodiment, the light shading layer 21 can use a black fire-resistant polyester film, or a black shading PET film. Thus, it forms a reflective sheet 2 having reflection function at its positive surface and light shading and fire resistant function at its negative surface. When assembly, it can assemble the light shading layer 21 of the reflective sheet 2 directly to the backplane 1. With compared with the first embodiment, since the light shading layer 21 is forming on the reflective sheet 2, it is possible to simplify the assembly step and save the cost.

In a third embodiment of a backlight module of the present invention, the backlight module comprises: a backplane 1, a reflective sheet 2 and other structural members. The reflective sheet 2 comprises a reflective surface and a non-reflective surface. Wherein, the non-reflective surface of the reflective sheet 2 is assembled to the backplane 1, and the reflective surface of the reflective sheet 2 is assembled toward the other structural members.

The other structural members are assembled according to the position shown in FIG. 1. From the bottom to the top, it sequentially provides with a light guide plate 91, optical sheets 2, a plastic frame 93, a glass assembly 94 and a front frame 95.

The difference between this embodiment and the first and the second embodiments is that this embodiment coats a fire-resistant particle layer on the non-reflective surface of the reflective sheet 2 corresponding to the hollow portions of the backplane 1.

The function of the fire-resistant particle layer and the above light shading film 3 and the light shading layer 21 is the same. It also shades the light transmitting through the reflective sheet 2 to prevent the light leakage and the 3D scan flashing problems when the module is operating and to solve safety issues at the same time.

In the assembly process, the fire-resistant particle layer may be coated after the reflective sheet 2 has been assembled to the backplane 1. Due to the non-hollow portions of the backplane 1 is able to shade part of the light transmitting through the reflective sheet 2. Coating only on the hollow portions of the backplane 1 to form the fire-resistant particle layer, it can also save the material and simplify the assembly steps on the basis of solving the light leakage and the 3D scan flashing problems when the module is operating.

The present invention also discloses an LCD device. The LCD device includes the backlight module disclosed at the above-described embodiments, and the specific implementation method will not repeat again.

The backlight module and the LCD device of the present invention have the following beneficial effects: Because a light shading film is disposed between the backplane with the hollow portion and reflective sheet, the light shading layer is adhered on the non-reflective surface of the reflective sheet, or a fire-resistant particle layer is coated on the non-reflecting surface of the reflective sheet corresponding to the hollow portion of the backplane. It can shade the light transmitting through the reflective sheet to avoid the leakage light and the 3D scan flashing of the backlight module and can achieve safety standards, simplify the assembly steps, and conducive to cost control.

The above content combines the preferred embodiments for detail description of the present invention. It is particularly pointed out that the above embodiments are only used to illustrate the present invention, and they are not used to limit the scope of the present invention. Other embodiments obtained under the premise of without paying creative labor by the person ordinary skill in the art are all belong to the claims of the present invention.

What is claimed is:

1. A backlight module comprising:
a backplane comprising a hollow portion;
a reflective sheet having a reflective surface and a non-reflective surface, and assembled to the backplane; and
a light shading layer disposed between the backplane and the reflective sheet for shading the hollow portion.

2. The backlight module according to claim 1, wherein, the light shading layer is a light shading film made from a fire-resistant material, and the light shading film is fixed to the backplane.

3. The backlight module according to claim 2, wherein, the light shading film comprises a black fire-resistant polyester film or a black shading PET film.

4. The backlight module according to claim 3, wherein, the light shading film has a similar shape corresponding to the hollow portion.

5. The backlight module according to claim 1, wherein, the light shading layer is made from a fire-resistant material and adhered to the non-reflective surface of the reflective sheet.

6. The backlight module according to claim 5, wherein, the light shading layer is a black fire-resistant polyester film.

7. The backlight module according to claim 6, wherein, the light shading layer is a fire-resistant particle layer coated on the non-reflective surface of the reflective sheet corresponding to the hollow portion of the backplane.

8. An LCD device comprising a backlight module, the backlight module comprising:
a backplane comprising a hollow portion;
a reflective sheet having a reflective surface and a non-reflective surface, and assembled to the backplane; and
a light shading layer disposed between the backplane and the reflective sheet for shading the hollow portion.

9. The LCD device according to claim 8, wherein, the light shading layer is a light shading film made from a fire-resistant material, and the light shading film is fixed to the backplane.

10. The LCD device according to claim 9, wherein, the light shading film comprises a black fire-resistant polyester film or a black shading PET film.

11. The LCD device according to claim 10, wherein, the light shading film has a similar shape corresponding to the hollow portion.

12. The LCD device according to claim 8, wherein, the light shading layer is made from a fire-resistant material and adhered to the non-reflective surface of the reflective sheet.

13. The LCD device according to claim 12, wherein, the light shading layer is a black fire-resistant polyester film.

14. The LCD device according to claim 13, wherein, the light shading layer is a fire-resistant particle layer coated on the non-reflective surface of the reflective sheet corresponding to the hollow portion of the backplane.
